(19) United States
(12) Patent Application Publication
(10) Pub. No.: US 2026/0351134 A1
(43) Pub. Date: Nov. 5, 2026

(54) SIGN LANGUAGE RECOGNITION METHOD AND DEVICE, AND READABLE STORAGE MEDIUM

(71) Applicant: GOERTEK INC., Weifang (CN)

(72) Inventors: Jiujian SUN, Weifang (CN); Zhipeng ZHU, Weifang (CN); Yufeng LI, Weifang (CN); Jiaming LI, Weifang (CN); Guoxin LI, Weifang (CN); Gaojian SHI, Weifang (CN); Mingming YANG, Weifang (CN); Yongfu CHEN, Weifang (CN); Yueqing CHEN, Weifang (CN); Baocheng LI, Weifang (CN); Tongquan ZHANG, Weifang (CN)

(21) Appl. No.: 19/727,518

(22) Filed: Jul. 1, 2026

Related U.S. Application Data
(63) Continuation of application No. PCT/CN2025/093142, filed on May 7, 2025.

(30) Foreign Application Priority Data
Aug. 29, 2024 (CN) 202411205689.1

(51) Int. Cl. G09B 21/00; G06N 3/0455; G06V 10/74; G06V 40/20

(52) U.S. Cl. CPC G09B 21/009; G06N 3/0455; G06V 10/761; G06V 40/28

(57) ABSTRACT

The present application provides a sign language recognition method and device, and a readable storage medium. The method includes: obtaining video data to be applied to sign language recognition; the video data includes multiple frame images; for each frame image, calculating a first similarity between the image and a preset reference image, and determining an image value corresponding to the image based on the first similarity; the image value is positively correlated with the first similarity, and the preset reference image is an image containing valid sign language content; and selecting keyframe images with image values greater than a preset threshold from each of the images, and inputting the keyframe images into a preset sign language recognition model to obtain sign language recognition results.

### CROSS-REFERENCE TO RELATED APPLICATIONS

The present application is a continuation application of International Application No. PCT/CN2025/093142, filed on May 7, 2025, which claims priority to Chinese Patent Application No. 202411205689.1, entitled in “SIGN LANGUAGE RECOGNITION METHOD AND DEVICE, AND READABLE STORAGE MEDIUM” and filed on Aug. 29, 2024. The disclosures of the above-mentioned applications are incorporated herein by reference in their entireties.

### TECHNICAL FIELD

The present application relates to the technical field of sign language recognition, and in particular to a sign language recognition method, a device and a readable storage medium.

### BACKGROUND

Sign language is an important way for deaf and mute people to obtain and express information. They typically communicate through sign language, which requires both parties to understand it. However, learning sign language requires a significant investment of time and effort for most hearing people, resulting in low sign language proficiency and difficulty communicating with deaf and mute individuals. Therefore, intelligent sign language recognition is of great significance for communication among deaf and mute people.

Traditional sign language recognition schemes collect video data of sign language users, then use deep learning models to extract sign language features from the video, and finally predict results based on these extracted features. However, because the collected sign language video data may contain some unintentional gesture interference frames, such as frames of hands lowered, raised, or blank frames, the accuracy of the above-mentioned sign language recognition schemes is relatively low.

Therefore, how to improve the accuracy of sign language recognition results is a technical problem that urgently needs to be solved in this field.

### SUMMARY

The main objective of the present application is to provide a sign language recognition method, a device, and a readable storage medium, aiming to solve the technical problem of how to improve the accuracy of sign language recognition results.

To achieve the above objective, the present application provides a sign language recognition method, including:
obtaining video data to be applied to sign language recognition; the video data includes multiple frame images;
for each frame image, calculating a first similarity between the image and a preset reference image, and determining an image value corresponding to the image based on the first similarity; the image value is positively correlated with the first similarity, and the preset reference image is an image containing valid sign language content; and
selecting keyframe images with image values greater than a preset threshold from each of the images, and inputting the keyframe images into a preset sign language recognition model to obtain sign language recognition results.

In an embodiment, the determining the image value corresponding to the image based on the first similarity includes:
obtaining adjacent frame images corresponding to the image, and calculating a second similarity between the image and the adjacent frame images; the adjacent frame images are a previous frame image or a next frame image; and
calculating a weighted sum of the first similarity and the second similarity, and determining the weighted sum as the image value corresponding to the image.

In an embodiment, the calculating the first similarity between the image and the preset reference image includes:
calculating a Pearson correlation coefficient between the image and the preset reference image, and determining the Pearson correlation coefficient between the image and the preset reference image as the first similarity.

In an embodiment, after the obtaining video data to be applied to sign language recognition, the method further includes:
obtaining an image sequence by arranging the images in chronological order, and determining a middle position of the image sequence; and
selecting the image corresponding to the middle position of the image sequence as a preset reference image.

In an embodiment, the sign language recognition model includes an input module, an encoding module, a decoding module, and a prediction head connected in sequence; the inputting the keyframe images into the preset sign language recognition model to obtain sign language recognition results includes:
embedding and positionally encoding the keyframe image through the input module to obtain an input vector;
inputting the input vector into the encoding module to obtain an encoding matrix; the encoding module is configured to encode the input vector;
inputting the encoding matrix into the decoding module to obtain a decoding matrix; the decoding module is configured to decode the encoding matrix; and
inputting the decoding matrix into the prediction head to obtain the sign language recognition results.

In an embodiment, the input module includes an image embedding module, a key point embedding module, and a position encoding module; the embedding and positionally encoding the keyframe image through the input module to obtain the input vector includes:
embedding the keyframe image through the image embedding module to obtain an image vector;
extracting key points from the keyframe image through the keypoint embedding module, and embedding the key points, to obtain a keypoint vector; and
performing position encoding on the image vector and the keypoint vector through the position encoding module to obtain an input vector; the input vector includes an image position encoding vector and a keypoint position encoding vector.

In an embodiment, the encoding module includes an image encoder stack, a keypoint encoder stack, and a fusion module; the inputting the input vector into the encoding module to obtain the encoding matrix includes:
inputting the image position encoding vector from the input vector into the image encoder stack to obtain an image encoding matrix;
inputting the keypoint position encoding vector from the input vector into the keypoint encoder stack to obtain a keypoint encoding matrix; and
performing a weighted fusion of the image encoding matrix and the keypoint encoding matrix by the fusion module to obtain the encoding matrix.

In an embodiment, the prediction head includes a pooling layer, multiple regularization layers, and an output layer; the inputting the decoding matrix into the prediction head to obtain the sign language recognition results includes:
inputting the decoding matrix into the pooling layer to obtain a fusion vector;
inputting the fusion vector into each of the regularization layers to obtain a regularization vector; and
inputting all the regularization vectors into the output layer to obtain the sign language recognition results.

In addition, in order to achieve the above objective, the present application also provides a sign language recognition device, including: a memory, a processor, and a computer program stored in the memory and executable on the processor; the computer program is configured to implement the steps of the sign language recognition method.

In addition, in order to achieve the above objective, the present application also provides a readable storage medium; the readable storage medium is a computer-readable storage medium, and a computer program is stored on the computer-readable storage medium; when the computer program is executed by a processor, the steps of the sign language recognition method are implemented.

The present application also provides a computer program product, including a computer program; when the computer program is executed by a processor, the steps of the above-described sign language recognition method are implemented.

One or more technical solutions proposed in the present application have at least the following technical effects:

Obtaining video data to be applied to sign language recognition; the video data includes multiple frame images; for each frame image, calculating a first similarity between the image and a preset reference image, and determining an image value corresponding to the image based on the first similarity; the image value is positively correlated with the first similarity, and the preset reference image is an image containing valid sign language content; and selecting keyframe images with image values greater than a preset threshold from each of the images, and inputting the keyframe images into a preset sign language recognition model to obtain sign language recognition results. Considering that sign language primarily involves finger and palm movements, the similarity between images is typically high, with only small areas of the fingers and/or palms showing differences. Conversely, when not using sign language, the hands are usually lowered, resulting in lower similarity. Therefore, in this embodiment, a similarity (i.e., first similarity) is calculated between each image and a preset reference image based on the preset reference image containing valid sign language content. The image value of each image is then evaluated based on this first similarity, which is positively correlated with the first similarity. This evaluation effectively represents the probability that each image contains valid sign language content. Keyframe images with a value greater than or equal to a preset threshold are then selected from all images. Sign language recognition is performed based on these keyframe images to obtain the recognition result. In other words, high-quality keyframe images with a high probability of containing valid sign language content are selected from the video data, while low-value, meaningless images are removed, thus reducing the interference of meaningless images on the recognition result and improving the accuracy of the sign language recognition. Furthermore, compared to the method of calculating the similarity between each frame image and adjacent frame images separately, the method of calculating the similarity between each frame image and a preset reference frame image in this embodiment can reduce the influence of initial blank frames and ending blank frames (blank frames refer to meaningless image frames without actual sign language meaning). If the adjacent frame image is a blank frame, the similarity between the current frame image and the adjacent frame image cannot effectively evaluate the image value of the current frame image, thereby further improving the accuracy of the sign language recognition results.

### BRIEF DESCRIPTION OF THE DRAWINGS

The accompanying drawings, which are incorporated in and form part of this specification, illustrate embodiments consistent with the present application and, together with the description, serve to explain the principles of the present application.

To more clearly illustrate the technical solutions in the embodiments of the present application or the related art, the drawings used in the description of the embodiments or the related art will be briefly introduced below. Obviously, for those skilled in the art, other drawings can be obtained based on these drawings without creative effort.

FIG. 1 is an illustrative flowchart of a sign language recognition method according to a first embodiment of the present application.

FIG. 2 is an illustrative flowchart of a keyframe image screening of the sign language recognition method of the present application.

FIG. 3 is an illustrative flowchart of an image embedding module of the sign language recognition method of the present application.

FIG. 4 is a schematic diagram of key points of hand involved in the sign language recognition method according to an embodiment of the present application.

FIG. 5 is an illustrative flowchart of the key point embedding module of the sign language recognition method of the present application.

FIG. 6 is a schematic diagram of the overall structure of the sign language recognition model of the sign language recognition method according to an embodiment of the present application.

FIG. 7 is another schematic diagram of the overall structure of the sign language recognition model of the sign language recognition method according to an embodiment of the present application.

FIG. 8 is a schematic diagram of the hardware operating environment of the sign language recognition device according to the embodiments of the present application.

The purpose, functional features and advantages of the present application will be further explained in conjunction with the embodiments and with reference to the accompanying drawings.

### DETAILED DESCRIPTION OF THE EMBODIMENTS

To make the above-mentioned objects, features, and advantages of the present application more apparent and understandable, the technical solutions of the embodiments of the present application will be clearly and completely described below with reference to the accompanying drawings. Obviously, the described embodiments are only some embodiments of the present application, and not all embodiments. Based on the embodiments of the present application, all other embodiments obtained by those skilled in the art without creative effort are within the protection scope of the present application.

Sign language videos can be viewed as ordered sequences containing a large amount of redundant information. Currently, sign language recognition for deaf and mute individuals mainly relies on single-image information. This method uses deep learning models to identify sign language information from images. However, this approach is often heavily influenced by the quality of the sign language expression and struggles to recognize less-than-perfect expressions. Another method is sensor-based sign language recognition. This method identifies hand trajectories and matches them against predefined templates to achieve sign language recognition. However, this method typically requires building a large number of highly standardized sign language trajectory templates and often necessitates the use of external devices such as data gloves, making it highly dependent on the hardware environment.

Currently, shot boundary detection (SBD) is a keyframe extraction algorithm used to extract keyframes from sign language videos. This allows for the selection of critical image frames for sign language recognition. SBD is a widely used and mature algorithm for determining keyframes in videos. The basic idea of this algorithm is to determine keyframes by detecting changes in visual content. However, sign language videos often contain numerous blank frames at the beginning and end. Since the SBD algorithm simply compares the current frame with the previous frame, it is heavily influenced by these initial and final blank frames, leading to wasted computational resources and inefficient keyframe calculation, resulting in lower accuracy in sign language recognition.

Based on this, the main solution of the present application is: obtaining video data to be applied to sign language recognition; the video data includes multiple frame images; for each frame image, calculating a first similarity between the image and a preset reference image, and determining an image value corresponding to the image based on the first similarity; the image value is positively correlated with the first similarity, and the preset reference image is an image containing valid sign language content; and selecting keyframe images with image values greater than a preset threshold from each of the images, and inputting the keyframe images into a preset sign language recognition model to obtain sign language recognition results.

The present application calculates the similarity between each image and a preset reference image, i.e., a first similarity, and evaluates the image value of each image based on this first similarity. Since image value is positively correlated with the first similarity, the evaluated image value effectively represents the probability that each image contains valid sign language content. Then, keyframe images with an image value greater than or equal to a preset threshold are selected from all images. Sign language recognition is performed based on these keyframe images to obtain the sign language recognition result. In other words, high-quality keyframe images with a high probability of containing valid sign language content are selected from the video data, while low-value, meaningless images are deleted, thereby reducing the interference of meaningless images on the recognition result and improving the accuracy of the sign language recognition result. Furthermore, the similarity calculation between each frame image and the preset benchmark frame image in the present application reduces the influence of initial and ending blank frames, further improving the accuracy of sign language recognition.

It should be noted that the execution subject of the various embodiments of the sign language recognition method of the present application can be a computing service device with data processing, network communication, and program execution functions, such as a tablet computer, personal computer, or mobile phone, or a sign language recognition device capable of realizing the above functions, such as augmented reality (AR) glasses, virtual reality (VR) glasses, smart glasses, or a robot. For example, AR glasses will be used as the execution subject in the description and explanation of the various embodiments of the sign language recognition method of the present application.

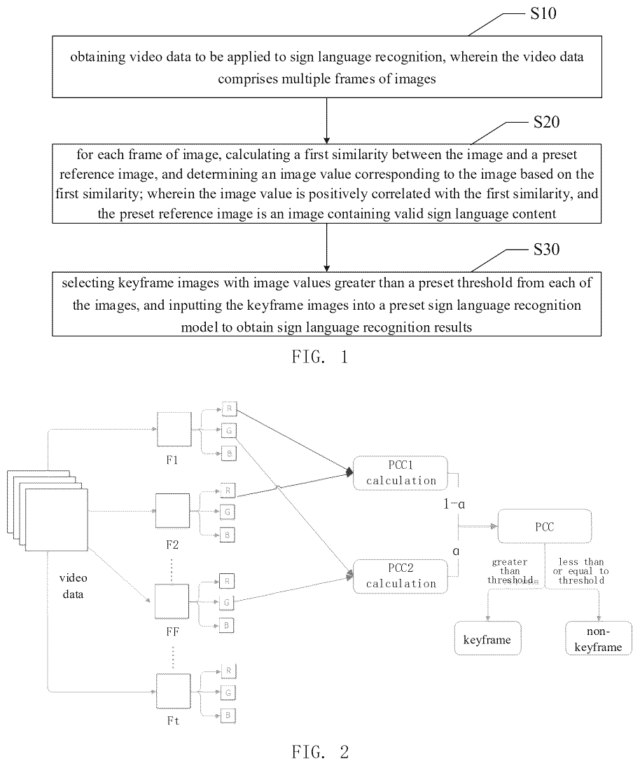

Based on this, the present application proposes a sign language recognition method according to a first embodiment. Referring to FIG. 1, the sign language recognition method includes steps S10 to S30:
Step S10: obtaining video data to be applied to sign language recognition; the video data includes multiple frame images;

The video data specifically refers to the captured sign language video. In other words, the video is composed of multiple frame images. For example, when a camera captures video, it captures images at a preset frame rate to obtain video data.

Furthermore, after obtaining the video data, image preprocessing can be performed on all images included in the video data. Subsequent steps are then executed based on the preprocessed images to further improve image quality. Image preprocessing includes, but is not limited to, deleting images with a sharpness below a certain preset threshold, deleting images with an illumination intensity below a certain preset threshold, deleting a preset frame image at a starting position (deleting the first preset frame image in the video data), and deleting a preset frame image at an ending position (deleting the last preset frame image in the video data). This embodiment does not impose specific limitations on these steps.
Step S20: for each frame image, calculating a first similarity between the image and a preset reference image, and determining an image value corresponding to the image based on the first similarity; the image value is positively correlated with the first similarity, and the preset reference image is an image containing valid sign language content;

After obtaining the video data, for each frame of the video data, calculating the first similarity between the frame image (hereinafter referred to as the current frame image) and the preset reference image. The first similarity is the similarity between the current frame image and the preset reference image.

The preset reference image is an image containing valid sign language content. Further, the preset reference image is one or more frames containing valid sign language content. If the preset reference image includes multiple frames, the first similarity between the image and the preset reference image can specifically be the average similarity, maximum similarity, or median similarity between the image and all images in the preset reference image, etc., without limitation. To reduce computational load, the preset reference frame is a single frame. Therefore, the embodiments of the present application are described and illustrated using the preset reference frame as a single frame.

It should be noted that an image containing valid sign language content means that the hand gestures in the image are sign language postures with actual sign language meaning.

Regarding the setting of the preset reference image, as one implementation method, relevant personnel can set the preset reference image in advance. As another implementation method, one frame containing valid sign language content can be selected from multiple frames included in the video data as the preset reference image.

In a first implementation method, after obtaining the video data for sign language recognition, the method further includes (as a alternative way, the method involves selecting one frame containing valid sign language content from multiple frames of video data as a preset reference image):
Step S201: obtaining an image sequence by arranging the images in chronological order, and determining the middle position of the image sequence.

Considering that sign language gestures typically have a start and end time, with the middle time usually consisting of continuous gestures, the middle position of this sequence can be any position other than a predetermined number of start and end positions. For example, if the image sequence length is 400, the middle position can be any position from the 50th element to the 300th element. Here, the sequence length of the image sequence is the number of image frames included in the sequence.

Furthermore, the middle position of the sequence can specifically be the very center of the image sequence. When the sequence length of the image sequence is even, the very center position can be any one of the two very center positions. For example, when the image sequence length is 5, the middle position of the sequence can be the position of the 3rd element. Or, when the image sequence length is 6, the middle position of the sequence can be either the position of the 3rd element or the position of the 4th element.
Step S202: selecting the image corresponding to the middle position of the image sequence as the preset reference image.

By selecting the image corresponding to the middle position of the sequence as the reference image, or in other words, selecting the image at the middle position of the sequence as the preset reference image, the efficient selection of the preset reference image is achieved.

In the second implementation, considering that the signer's arm and body form a certain angle during sign language expression, let (x1, y1) be the position coordinates of the elbow joint and (x2, y2) be the position coordinates of the wrist. The angle s formed by these two points and the angle in the opposite direction of gravitational acceleration can represent the on/off state of the sign language gesture. When sign language is being used, s is usually less than a certain value (such as 150°, 160°, etc.), while when no sign language is being used, s is usually greater than or equal to this certain value. Based on this, the s value of the image can be calculated, and a frame with an s value less than a preset threshold can be selected as the preset reference frame image.

As a third implementation, a preset gesture detection algorithm, such as support vector machine, random forest, or deep learning model, can be used to determine whether the gestures in an image have actual sign language meaning. If the preset gesture recognition algorithm detects that a gesture in a frame image has actual sign language meaning, then that frame image is selected as a preset reference image. It should be noted that, considering the generally long duration of sign language videos, which include a large number of images, and the high complexity and computational cost of current gesture detection algorithms, inputting all images into the preset gesture detection algorithm and then filtering for high-value keyframe images would require significant computational resources and be time-consuming. Therefore, images can be input into the preset gesture detection algorithm sequentially according to time order until a frame with actual sign language meaning is detected, at which point the detection process ends.

It should be noted that the above are only four feasible implementation methods for setting a preset reference image provided in this embodiment. This embodiment does not impose specific limitations on the specific implementation methods for setting the preset reference image.

It should be noted that, unless otherwise specified, the images described in the embodiments of the present application refer only to the images in the obtained video data.
Step S30: selecting keyframe images with image values greater than a preset threshold from each of the images, and inputting the keyframe images into a preset sign language recognition model to obtain sign language recognition results.

Selecting keyframe images whose image value is greater than a preset threshold from among the images. Specifically, the keyframe images can be all images whose image value is greater than the preset threshold. The preset threshold can be any value set in advance, and this embodiment does not impose any specific restrictions on it.

After selecting keyframe images, these images are input into a pre-defined sign language recognition model to obtain the sign language recognition result, which can be the final output of the sign language recognition model. By using a sign language recognition model for sign language recognition, compared to sensor-based sign language recognition methods, there is no need to rely on additional sensor devices such as sign language gloves, nor is it necessary to pre-build a large number of sign language trajectory templates, thus reducing the implementation cost of sign language recognition.

In this embodiment, video data to be recognized for sign language is obtained; the video data includes multiple frame images; for each frame image, a first similarity between the image and a preset reference image is calculated, and the image value corresponding to the image is determined based on the first similarity; the image value is positively correlated with the first similarity, and the preset reference image is an image containing valid sign language content; key frame images with image values greater than a preset threshold are selected from each image, and the key frame images are input into a preset sign language recognition model to obtain the sign language recognition result. Considering that sign language primarily involves finger and palm movements, the differences between images are typically limited to small areas of the fingers and/or palms. However, when the signer is not using sign language, their hands are usually lowered, resulting in lower similarity to images used in sign language. Therefore, this embodiment calculates the similarity (first similarity) between each image and a preset reference image containing valid sign language content. The image value of each image is then evaluated based on this first similarity, which is positively correlated with the first similarity. This evaluation effectively represents the probability that each image contains valid sign language content. Keyframe images with a value greater than or equal to a preset threshold are then selected from all images. Sign language recognition is performed based on these keyframe images to obtain the recognition result. In other words, high-quality keyframe images with a high probability of containing valid sign language content are selected from the video data, while low-value, meaningless images are removed. This reduces the interference of meaningless images on the recognition result and improves the accuracy of the sign language recognition. Furthermore, compared to the method of calculating the similarity between each frame image and adjacent frame images separately, this embodiment calculates the similarity between each frame image and a preset reference frame image, which can reduce the influence of initial blank frames and ending blank frames. If the adjacent frame is a blank frame, the similarity between the current frame image and the adjacent frame image cannot effectively evaluate the image value of the current frame image, further improving the accuracy of sign language recognition results.

Based on the first embodiment of the present application, in the second embodiment of the present application, the content that is the same as or similar to that in the first embodiment described above can be referred to the above description and will not be repeated hereafter. Based on this, the step of determining the image value corresponding to the image based on the first similarity includes:
Step A10: obtaining the adjacent frame image corresponding to the image, and calculating the second similarity between the image and the adjacent frame image; the adjacent frame image is the previous frame image or the next frame image;

It should be noted that a second similarity is calculated between the current frame image and the adjacent frame images, and this second similarity is the similarity between the current frame image and the adjacent frame images.

The adjacent frame image can be either the previous frame image or the next frame image; this embodiment does not impose any specific restrictions on this.
Step A20: calculating the weighted sum of the first similarity and the second similarity, and determining the weighted sum as the image value corresponding to the image.

Calculating the weighted sum of the first similarity and the second similarity, and determining this weighted sum as the image value corresponding to the current frame image. Specifically, this weighted sum can be obtained by weighted summation of the first similarity and the second similarity.

The weights corresponding to the first similarity and the second similarity can be set in advance, and the weighted sum value can be obtained by weighted summation based on the weights corresponding to the first similarity and the second similarity.

Furthermore, the weight corresponding to the first similarity is denoted as the first weight, and the weight corresponding to the second similarity is denoted as the second weight. Then, the sum of the first weight and the second weight can be one. The first weight and the second weight can be the same or different, and this embodiment does not impose specific restrictions on this.

In one possible implementation, the step of calculating the first similarity between the image and the preset reference image includes:
Step B10: calculating the Pearson correlation coefficient between the image and the preset reference image, and determining the Pearson correlation coefficient between the image and the preset reference image as the first similarity.

The Pearson correlation coefficient (PCC), also known as the Pearson product-moment correlation coefficient, is a statistical indicator that measures the degree of linear correlation between two variables.

Specifically, the Pearson correlation coefficient can be expressed by the formula:

$$PCC ( P , Q ) = \frac{1}{N - 1} \frac{1}{M - 1} {\sum }_{i = 1}^{N} {\sum }_{j = 1}^{M} ( \frac{P ( i , j ) - {μ}_{p}}{{σ}_{p}} ) ( \frac{Q ( i , j ) - {μ}_{q}}{{σ}_{q}} ) ;$$

Where, PCC(P,Q) represents the Pearson correlation coefficient between image P and image Q; N represents the number of pixels in the horizontal direction of the image; M represents the number of pixels in the vertical direction of the image; P(i,j) represents the pixel value of the i-th row and j-th column pixel of image P; Q(i,j) represents the pixel value of the i-th row and j-th column pixel of image P; μp represents the average pixel value of all pixels in image P; μq represents the average pixel value of all pixels in image Q; σp represents the root mean square error of all pixel values in image P; and σq represents the root mean square error of all pixel values in image Q.

Furthermore, referring to FIG. 2, considering that the pixel value of each frame image can be decomposed into three channels: R, G, and B, the PCC calculation formula described above can be used to calculate the PCC value of each channel between two frames. Letting the PCC value between the R channels of two frames be PCC_{R}, the PCC value between the G channels of two frames be PCC_{G}, and the PCC value between the B channels of two frames be PCC_{B}. Then, the PCC value between two frames can be the average of PCC_{R}, PCC_{G}, and PCC_{B}.

For example, to help understand the technical concept or principle of the sign language recognition method after combining this embodiment with the first embodiment, please refer to FIG. 2. The specific sign language recognition process is as follows:
1. Obtaining the video data to be used for sign language recognition. The video data includes t frames, which are [F1, F2, F3 . . . Fi . . . Ft], where F=ᵢ represents the i-th frame. The middle frame of the video data is used as the preset reference image FF.
2. Calculating the PCC value between the i-th frame image Fᵢ and the preset reference image FF, denoted as PCC1. Selecting the next frame image Fᵢ₊₁ as the adjacent frame image of the i-th frame image, and calculating the PCC value between the next frame Fᵢ₊₁ and Fᵢ, denoted as PCC2. It should be noted that for the last frame image, the previous frame image can be selected as the adjacent frame image of that image.
3. The weighted sum of PCC1 and PCC2 is used to obtain PCCi. Specifically, it can be expressed by the formula: PCCᵢ=αPCC(i,FF)+(1−α)PCC(i,Fᵢ₊₁), where PCC(i,FF) represents the PCC value between Fᵢ and FF, i.e., PCC1, PCC(i,Fᵢ₊₁) represents the PCC value between Fᵢ and Fᵢ₊₁, i.e., PCC2, and α represents the first weight.
4. Determining the image value of the i-th frame as PCCᵢ. If PCCᵢ is greater than the preset threshold τ, selecting the i-th frame Fᵢ as the keyframe image. Otherwise, determining the i-th frame Fᵢ as a non-keyframe image. Finally, extracting the complete keyframe sequence, which is a sequence composed of all keyframe images.
5. Inputting the keyframe sequence into the preset sign language recognition model and outputting the sign language recognition result.

It should be noted that the above examples are only used to help understand the present application and do not constitute a limitation on the sign language recognition method of the present application. Any simple modifications based on this technical concept are within the protection scope of the present application.

Based on the first and/or second embodiments of the present application, in the third embodiment of the present application, the content that is the same as or similar to the first and second embodiments described above can be referred to the above description and will not be repeated hereafter. Based on this, the sign language recognition model includes an input module, an encoding module, a decoding module, and a prediction head connected in sequence. The step of inputting the keyframe image into the preset sign language recognition model to obtain the sign language recognition result includes:
Step C10: embedding and positionally encoding the keyframe image by the input module to obtain the input vector;

Considering that the Transformer model (a deep learning model based on self-attention) has achieved significant breakthroughs compared to traditional recurrent neural networks in handling long sequence tasks, it introduces a self-attention mechanism that allows the model to capture global dependencies and distribute information across multiple subspaces through multi-head attention techniques, thereby significantly enhancing the model's expressive and understanding capabilities. The architectural advantage of the Transformer model lies in its equal treatment of all elements within a sequence, enabling the model to recognize and understand the rich semantic relationships between elements, especially excelling in understanding relationships between distant sequence elements. Therefore, in this embodiment, the sign language recognition model is specifically a Transformer model.

Specifically, the Transformer model includes an input module, an encoding module, a decoding module, and a prediction head connected in sequence. The input module is used to embed and positionally encode the keyframe images.

Embedding is the process of converting input data (such as words, characters, sentences, or any serializable entity) into a fixed-length vector representation. Embedding is the foundation for a model to understand input data.

Positional encoding refers to adding information about the position of each word in a sentence, also known as “information fragment”. Specifically, absolute positional encoding, relative positional encoding, etc. can be used, but this embodiment does not impose any specific restrictions on this.
Step C20: inputting the input vector into the encoding module to obtain the encoding matrix; the encoding module is used to encode the input vector;

The input vector output from the keyframe image after passing through the input module is transmitted to the encoding module. The encoding module encodes the input vector, converting it into a series of feature vectors, i.e., the encoding matrix, and then inputs the encoding matrix into the decoding module.

Personnel can design the encoding module according to actual needs, and the encoding matrix is the output of the encoding module. In one specific implementation, the encoding module can be an encoder stack consisting of one or more encoders connected in sequence. In this case, the encoding matrix is the output of the encoder stack, that is, the output of the last encoder in the encoder stack.
Step C30: inputting the encoding matrix into the decoding module to obtain the decoding matrix; the decoding module is used to perform decoding processing on the encoding matrix;

The decoding module receives the encoding matrix input from the encoding module, decodes the encoding matrix to obtain the output sequence, i.e., the decoding matrix, and inputs the decoding matrix into the prediction head.

Personnel can design decoding modules according to actual needs, and the decoding matrix is the output of the decoding module. In one specific implementation, the decoding module can be a decoder stack consisting of one or more decoders connected in sequence. In this case, the decoding matrix is the output of the decoder stack, that is, the output of the last layer of the decoder in the decoder stack.
Step C40: inputting the decoding matrix into the prediction head to obtain the sign language recognition result.

It should be noted that the sign language recognition result is the output of the prediction head.

In the Transformer model, the prediction head is used to convert the model's internal representation into the final prediction output. In this embodiment, the prediction head is used to convert the decoding matrix into the final prediction output, which is the sign language recognition result.

Personnel can design a prediction head according to actual needs. In one specific implementation, the prediction head includes a pooling layer, a regularization layer (dropout), a fully connected layer and a softmax function connected in sequence, and finally predicts the output through the softmax function.

In one possible implementation, the input module includes an image embedding module, a keypoint embedding module, and a position encoding module. The step of obtaining an input vector by embedding and position encoding the keyframe image through the input module includes:
Step D10: embedding the keyframe image by using the image embedding module to obtain an image vector;

The image embedding module is used to embed keyframe images to obtain image vectors. Specifically, referring to FIG. 3, the embedding process is as follows:
(1) First, scaling the image to a uniform size, such as 224×224×3. Then, dividing the image into small patches, each patch having the same size, such as 16×16×3. Then, arranging the small patches.
(2) Performing an Embedding operation on the arranged patches to obtain the image vector.
Step D20: extracting key points from the keyframe image through the key point embedding module, and performing embedding processing on the key points to obtain key point vectors;

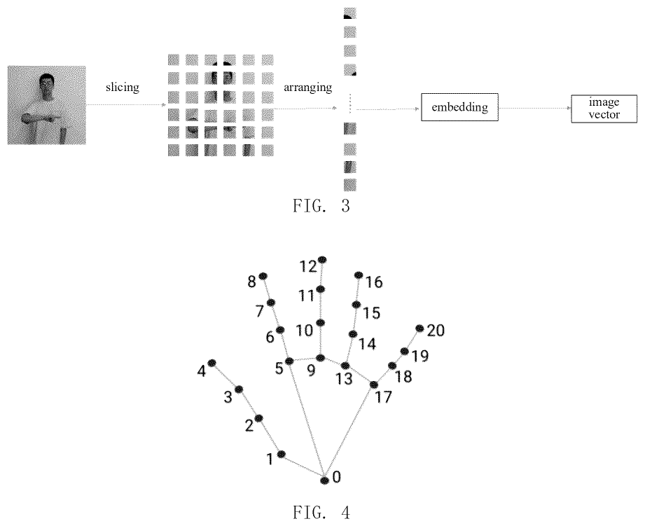

The keypoint embedding module is used to extract keypoints (actually, coordinates) from keyframe images. Specifically, it can extract keypoints of the face and hands from keyframe images. Keypoints of the hands are denoted as hand keypoints, and keypoints of the face as facial keypoints. Specifically, a preset number of hand keypoints and a preset number of facial keypoints can be extracted. The preset number of facial keypoints may include eye keypoints (keypoints for the glasses), nose keypoints (keypoints for the nose), mouth keypoints (keypoints for the mouth), and contour keypoints (keypoints for the facial contour). In one specific embodiment, referring to FIG. 4, 21 hand keypoints are extracted from a single hand based on the keyframe image, for a total of 42 hand keypoints from both hands. Simultaneously, 58 facial keypoints are extracted, specifically including 17 contour keypoints, 12 eye keypoints, 9 nose keypoints, and 20 mouth keypoints.

Understandably, a key point can be represented by coordinates, thereby extracting each key point actually as one coordinate.

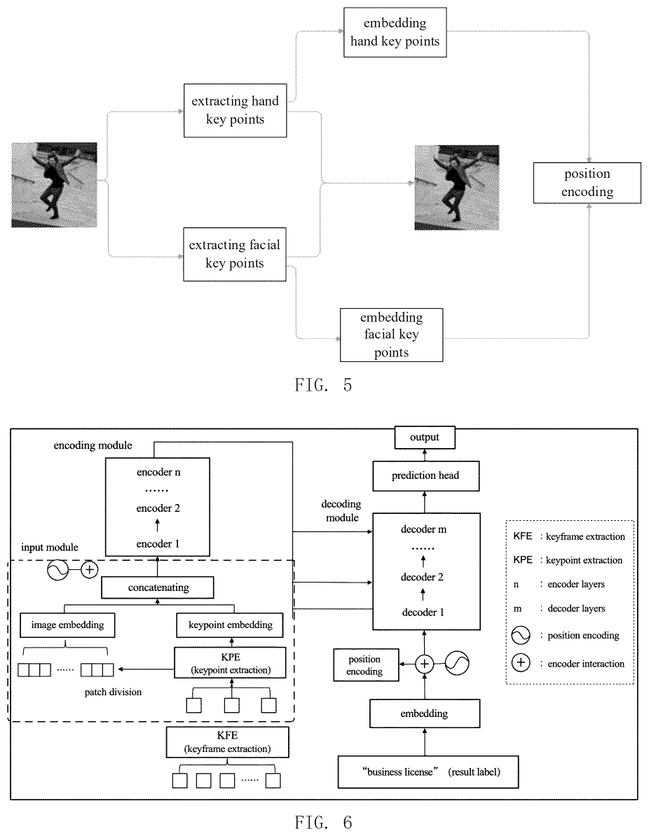

For example, referring to FIG. 5, key points are extracted from the keyframe image, specifically hand key points and facial key points. The extracted hand key points and facial key points are embedded to obtain key point vectors, that is, the key point coordinates are embedded. Then, the key point vectors are input to the position encoding module for position encoding.
Step D30: positionally encoding the image vector and the key point vector by the position encoding module to obtain an input vector; the input vector includes an image position encoding vector and a key point position encoding vector.

The input vector is obtained by performing positional encoding on the image vector and the key point vector respectively through the positional encoding module. The input vector includes the image positional encoding vector and the key point positional encoding vector. Specifically, the image positional encoding vector is the vector obtained by positional encoding the image vector, and the key point positional encoding vector is the vector obtained by positional encoding the key point vector.

In this embodiment, to allow the model to focus more on the hand and facial information of the sign language interpreter during the expression of sentences, a key point embedding module is set up to extract key points of the hands and face in the image, thereby improving the performance of the model. At the same time, to avoid the influence of noise on key points, an image embedding module is set up to embed key frame images, thereby fusing data from both the image and key points (actually text data in coordinate form) modalities for sign language recognition. By utilizing the complementary advantages of the two modalities of data, features are learned together, further improving the accuracy of sign language recognition results.

For example, to help understand the technical concept or principle of the sign language recognition model in this embodiment, please refer to FIG. 6. The sign language recognition model specifically includes an input module, an encoding module, a decoding module, and a prediction head connected in sequence. The encoding module includes n layers of encoders connected in sequence, the decoding module includes m layers of decoders connected in sequence, and the input module includes an image embedding module and a key point embedding module. The image embedding module and the key point embedding module are respectively connected to the position encoding module.

Based on this sign language recognition model, after extracting keyframe images from the video data (i.e., key frame extraction (KEF) as shown in FIG. 6), the extracted keyframe images are input into the input module of the sign language recognition model. The image embedding module and keypoint embedding module in the input module embed the images and keypoints respectively, then concatenate the outputs of the two embeddings. This output is then sequentially passed through position encoding, an n-layer encoder connected in sequence, an m-layer decoder connected in sequence, and a prediction head to obtain the model's final output, which is the sign language recognition result. It should be noted that the final output of the n-layer encoder is input into each of the m-layer decoders.

It should be noted that if the current process is training a sign language model, the training result label (as shown in FIG. 6, “business license”), which is the expected output of the model, will also be embedded and positionally encoded in sequence before being input into the decoding module. At the same time, the keyframe image corresponding to the result label will be input into the input module. Based on the input of the result label and the input of the image data, the sign language recognition model will be trained to obtain the trained sign language recognition model.

It should be noted that the above examples are only used to help understand the present application and do not constitute a limitation on the structure of the sign language recognition model of the present application. Any simple transformations based on this technical concept are within the protection scope of the present application.

Based on the first, second, and/or third embodiments of the present application, in the fourth embodiment of the present application, the content that is the same as or similar to the above-described first, second, and third embodiments can be referred to the above description and will not be repeated hereafter. Based on this, the encoding module includes an image encoder stack, a keypoint encoder stack, and a fusion module. The step of inputting the input vector into the encoding module to obtain the encoding matrix includes:
Step E10: inputting the image position encoding vector in the input vector into the image encoder stack to obtain the image encoding matrix;

It should be noted that this image encoder stack consists of one or more encoders connected in sequence. The image encoding matrix is the output of the image encoder stack, that is, the output of the last encoder layer in the image encoder stack.
Step E20: inputting the key point position encoding vector in the input vector into the key point encoder stack to obtain the key point encoding matrix;

It should be noted that the keypoint encoder stack consists of one or more encoders connected in sequence, and the keypoint encoding matrix is the output of the keypoint encoder stack, that is, the output of the last encoder layer in the keypoint encoder stack.

The number of encoder layers in the keypoint encoder stack can be the same as or different from the number of encoder layers in the image encoder stack; this embodiment does not impose a specific limitation on this. In some embodiments, the number of encoder layers in the image encoder is the same as the number of encoder layers in the keypoint encoding stack.
Step E30: weighting and fusing the image encoding matrix and the key point encoding matrix by the fusion module to obtain the encoding matrix.

The fusion module is connected to both the image encoder stack and the keypoint encoder stack to fuse the outputs of the image encoder stack and the keypoint encoder stack.

Furthermore, the image encoding matrix and the keypoint encoding matrix can be weighted and fused based on their respective fusion weights to obtain the encoding matrix. Regarding the setting of the fusion weights, relevant personnel can set the fusion weights corresponding to the image encoding matrix and the keypoint encoding matrix separately, or the fusion weights can be set as model parameters to optimize the fusion weights during the sign language recognition model training process. This embodiment does not impose specific limitations on this.

Letting p be the fusion weight corresponding to the image coding matrix, IA be the image coding matrix, q be the fusion weight corresponding to the keypoint coding matrix, KA be the keypoint coding matrix, and EA be the coding matrix. Then EA can be expressed by the formula EA=p*IA+q*KA. In one specific implementation, the sum of p and q is one.

In this embodiment, an image encoder stack and a keypoint encoder stack are set to encode the image encoding vector and the keypoint encoding vector respectively. This is equivalent to using encoder stacks to encode image data and text data separately. As a result, the characteristics of each data type can be better utilized, the model performance can be improved, the computational cost can be reduced, and the behavior of each encoder stack can be more easily understood and explained, thereby enhancing the interpretability and customizability of the model. Furthermore, the image and text encoders can be tuned separately, which helps to stabilize the training process.

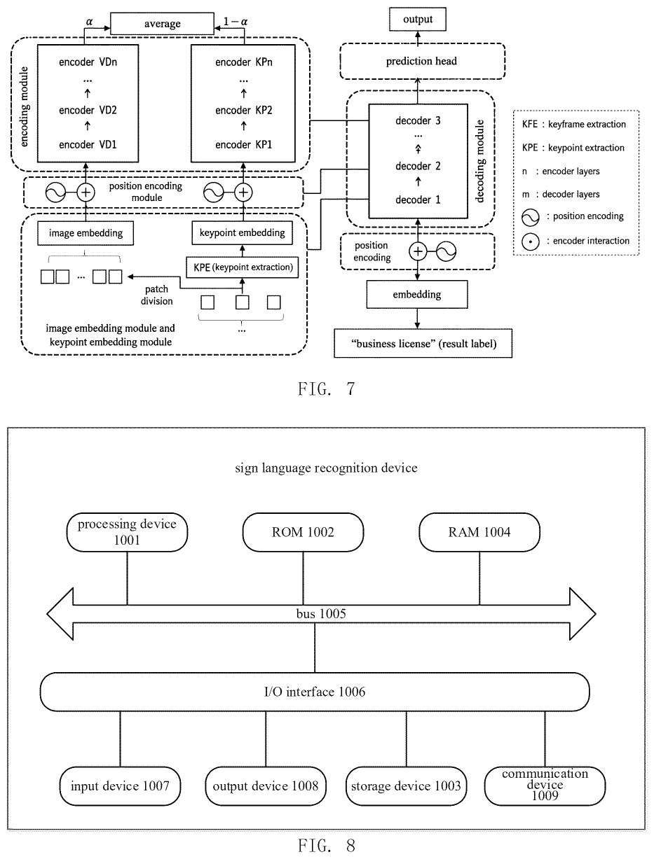

For example, to help understand the technical concept or principle of the sign language recognition model after combining this embodiment and the third embodiment, please refer to FIG. 7. The sign language recognition model specifically includes an input module, an encoding module, a decoding module, and a prediction head connected in sequence. The encoding module includes an image encoder stack, a keypoint encoder stack, and a fusion module. The image encoder stack includes n layers of encoders (Encoder VD) connected in sequence, and the keypoint encoder stack includes n layers of encoders (Encoder KP) connected in sequence. The decoding module includes m layers of decoders connected in sequence. The input module includes an image embedding module and a keypoint embedding module, which are respectively connected to the position encoding module.

The fusion module performs weighted fusion of the outputs of the image encoder stack and the keypoint encoder stack, and inputs the fusion result into each decoder of the decoder module. Specifically, the fusion weight corresponding to the image encoding matrix output by the image encoder stack is α, and the fusion weight corresponding to the keypoint encoding matrix output by the keypoint encoder stack is 1−α. The image encoding matrix and the keypoint encoding matrix are weighted and fused based on their respective fusion weights.

The processing mechanisms of other modules can be referred to the description in FIG. 6 above, and will not be repeated here.

It should be noted that the above examples are only used to help understand the present application and do not constitute a limitation on the structure of the sign language recognition model of the present application. Any simple transformations based on this technical concept are within the protection scope of the present application.

Based on the first, second, third, and/or fourth embodiments of the present application, in the fifth embodiment of the present application, the content that is the same as or similar to the above-described first, second, third, and fourth embodiments can be referred to the above description and will not be repeated hereafter. Based on this, the prediction head includes a pooling layer, multiple regularization layers, and an output layer. The step of inputting the decoding matrix into the prediction head to obtain the sign language recognition result includes:
Step F10: inputting the decoding matrix into the pooling layer to obtain the fusion vector;

It should be noted that this fusion vector is the output of the pooling layer.

This pooling layer fuses the vector sequences in the feature matrix to aggregate them into a fused vector with fixed dimensions and a fixed length.

Pooling layers aggregate the output sequences. In the Transformer model, after the sequence is processed by multiple layers of self-attention mechanisms and feedforward neural networks in the encoder and decoder, a series of hidden states are obtained, which are representation vectors at each position. These representation vectors contain the semantic information of the input sequence. In order to aggregate these vectors into a vector representation with fixed dimensions and fixed length, a pooling operation is required.

The pooling layer can specifically be an average pooling layer, a max pooling layer, a global pooling layer, etc., and this embodiment does not impose any specific limitations on it. Considering that compared with other pooling operations, the average pooling operation can preserve the overall characteristics of the sequence because it performs an averaging operation on the sequence, it not only considers the maximum and minimum features in the sequence, but also the overall trend and distribution. Average pooling can also enhance robustness and reduce overfitting. Based on this, in some embodiments, the pooling layer is specifically an average pooling layer.
Step F20: inputting the fusion vector into each of the regularization layers to obtain the regularization vector;

It should be noted that this regularization vector is the output of the regularization layer.

The regularization vector (Dropout) is a technique that randomly “deactivating” (i.e. temporarily ignoring) a portion of neurons in a neural network during training. Deactivated neurons do not participate in computation during the current forward and backward propagation. By randomly “deactivating” a portion of neurons in the network during training, the network's dependence on specific training samples is reduced, thereby improving the model's ability to generalize on unseen data.

The fusion vector is obtained by randomly deactivating the fusion vector through multiple regularization layers (Dropout), that is, the fusion vector is input into each regularization layer.

It should be noted that the dropout ratios of each regularization layer can be the same or different, and this embodiment does not impose specific restrictions on this. Considering that different dropout ratios can provide different regularization strengths, thereby improving the model's generalization ability; applying different dropout ratios can increase model diversity, allowing the model to be trained under different configurations; this diversity helps the model to better adapt to unknown data during use, and allows for customization of different dropout ratios, thus enabling more flexible control of the model's training process. This helps in finding the optimal training strategy to balance the model's accuracy and generalization ability. Therefore, in some embodiments, the dropout ratios of each regularization layer are different.

The dropout ratio of the regularization layer refers to the proportion of neurons dropped by the regularization layer.
Step F30: inputting all the regularization vectors into the output layer to obtain the sign language recognition result.

It should be noted that the sign language recognition result is the output of the output layer.

Relevant personnel can design the output layer according to actual needs. In one specific implementation, the output layer includes a fully connected layer and a softmax function connected in sequence.

In one possible implementation, the output layer includes multiple fully connected layers and a prediction layer, with each fully connected layer corresponding to a regularization layer. The step of converting all regularization vectors into target probability distribution vectors through the output layer and outputting gesture recognition results based on the target probability distribution vectors includes:
Step F301: inputting each of the regularization vectors into the corresponding connected fully connected layer to obtain a linear vector;

It should be noted that the linear vector is the output of the fully connected vector.

The number of fully connected layers and regularization layers is the same, and they are connected one-to-one. Each fully connected layer performs feature integration processing on the input regularization vector to obtain a linear vector, and then outputs this linear vector. For example, supposing that the i-th fully connected layer is connected to the i-th regularization layer, and the regularization vector output by the i-th regularization layer is Di, then Di is input to the i-th fully connected layer, which processes the input Di and outputs a linear vector Li. Here, i can take values from i to N, where N is the total number of regularization layers or fully connected layers.
Step F302: converting each linear vector into a probability distribution vector by the prediction layer, fusing the probability distribution vectors to obtain a target probability distribution vector, and outputting the gesture recognition result based on the target probability distribution vector.

It should be noted that this prediction layer includes a softmax function. After a linear vector is input into the softmax function, it is converted into a probability distribution vector. Having obtained the probability distribution vectors corresponding to each linear vector, a weighted fusion of all probability distribution vectors can be performed to obtain the target probability distribution vector. For example, the average vector of all probability distribution vectors can be calculated (the average value of the elements at the same position in all probability distribution vectors is used to obtain the vector). This average vector is then determined as the target probability distribution vector. After obtaining this target probability distribution vector, the final result, i.e., the gesture recognition result, can be output based on the target probability distribution vector.

In this embodiment, multiple regularization layers are set in the prediction head, and multiple different sub-network models are generated using multiple regularization layers, thereby improving the generalization ability of the sign language recognition algorithm model and thus improving the stability of the sign language recognition results.

Furthermore, the present application also proposes a sign language recognition device, which includes: a memory, a processor, and a computer program stored in the memory and executable on the processor. The computer program is configured to implement the steps of the sign language recognition method described above.

Referring to FIG. 8, a schematic diagram of a structure suitable for implementing the sign language recognition device according to an embodiment of the present application is shown. The sign language recognition device in the present application may also include, but is not limited to, mobile terminals such as augmented reality (AR) glasses, robots, laptops, digital broadcast receivers, personal digital assistants (PDAs), portable application descriptions (PADs), portable media players (PMPs), etc., as well as fixed terminals such as digital TVs, desktop computers, etc. The sign language recognition device shown in FIG. 8 is merely an example and should not impose any limitations on the functionality and scope of use of the embodiments of the present application.

As shown in FIG. 8, the sign language recognition device may include a processing device 1001 (e.g., a central processing unit, a graphics processing unit, etc.), which can perform various appropriate actions and processes according to a program stored in a read-only memory (ROM) 1002 or a program loaded from a storage device 1003 into a random access memory (RAM) 1004. The RAM 1004 also stores various programs and data required for the operation of the sign language recognition device. The processing device 1001, ROM 1002, and RAM 1004 are interconnected via a bus 1005. An input/output (I/O) interface 1006 is also connected to the bus. Typically, the following systems can be connected to I/O interface 1006: input devices 1007 including, for example, touchscreens, touchpads, keyboards, mice, image sensors, microphones, accelerometers, gyroscopes, etc.; output devices 1008 including, for example, liquid crystal displays (LCDs), speakers, vibrators, etc.; storage devices 1003 including, for example, magnetic tapes, hard disks, etc.; and communication devices 1009. Communication device 1009 allows the sign language recognition device to communicate wirelessly or wiredly with other devices to exchange data. Although a sign language recognition device with various systems is shown in the figure, it should be understood that it is not required to implement or possess all the systems shown. More or fewer systems may be implemented alternatively.

Specifically, according to the embodiments disclosed in the present application, the processes described above with reference to the flowcharts can be implemented as computer software programs. For example, embodiments disclosed in the present application include a computer program product including a computer program carried on a computer-readable medium, the computer program containing program code for performing the methods shown in the flowcharts. In such embodiments, the computer program can be downloaded and installed from a network via a communication device, or installed from storage device 1003, or installed from ROM 1002. When the computer program is executed by processing device 1001, it performs the functions defined in the methods of the embodiments disclosed in the present application.

The sign language recognition device provided in the present application, employing the sign language recognition method described in the above embodiments, can solve the technical problem of how to improve the accuracy of sign language recognition results. Compared with the related art, the beneficial effects of the sign language recognition device provided in the present application are the same as those of the sign language recognition method provided in the above embodiments, and other technical features of this sign language recognition device are the same as those disclosed in the previous embodiment method, and will not be repeated here.

It should be understood that the various parts disclosed in the present application can be implemented using hardware, software, firmware, or a combination thereof. In the description of the above embodiments, specific features, structures, materials, or characteristics can be combined in any suitable manner in one or more embodiments or examples.

The above are merely specific embodiments of the present application, but the protection scope of the present application is not limited thereto. Any variations or substitutions that can be easily conceived by those skilled in the art within the scope of the technology disclosed in the present application should be included within the protection scope of the present application. Therefore, the protection scope of the present application should be determined by the scope of the claims.

In addition, to achieve the above objectives, embodiments of the present application also provide a readable storage medium having computer-readable program instructions (i.e., a computer program) stored thereon, the computer-readable program instructions being used to execute the sign language recognition method in the above embodiments.

The computer-readable storage medium provided in the embodiment of the present application may be, for example, a USB flash drive, but is not limited to, an electrical, magnetic, optical, electromagnetic, infrared, or semiconductor system, device, or any combination thereof. More specific examples of a computer-readable storage medium may include, but are not limited to: an electrical connection having one or more wires, a portable computer disk, a hard disk, random access memory (RAM), read-only memory (ROM), erasable programmable read-only memory (EPROM or flash memory), optical fiber, portable compact disk read-only memory (CD-ROM), optical storage device, magnetic storage device, or any suitable combination thereof. In this embodiment, the computer-readable storage medium may be any tangible medium containing or storing a program that can be used by or in conjunction with an instruction execution system, system, or device. The program code contained on the computer-readable storage medium may be transmitted using any suitable medium, including but not limited to: wires, optical cables, radio frequency (RF), etc., or any suitable combination thereof.

The aforementioned computer-readable storage medium may be included in the sign language recognition device; or it may exist independently and not be assembled into the sign language recognition device.

The aforementioned computer-readable storage medium carries one or more programs that, when executed by a sign language recognition device, cause the sign language recognition device to: obtain video data to be recognized for sign language; the video data includes multiple frame images; for each frame image, calculate a first similarity between the image and a preset reference image, determine the image value corresponding to the image based on the first similarity; the image value is positively correlated with the first similarity, and the preset reference image is an image containing valid sign language content; select keyframe images with image values greater than a preset threshold from the images, and input the keyframe images into a preset sign language recognition model to obtain a sign language recognition result.

Computer program code for performing the operations of the present application can be written in one or more programming languages or a combination thereof, including object-oriented programming languages such as Java, Smalltalk, and C++, as well as conventional procedural programming languages such as the “C” language or similar programming languages. The program code can be executed entirely on the user's computer, partially on the user's computer, as a standalone software package, partially on the user's computer and partially on a remote computer, or entirely on a remote computer or server. In cases involving remote computers, the remote computer can be connected to the user's computer via any type of network—including a local area network (LAN) or a wide area network (WAN)—or can be connected to an external computer (e.g., via the Internet using an Internet service provider).

The flowcharts and block diagrams in the accompanying drawings illustrate the architecture, functionality, and operation of possible implementations of systems, methods, and computer program products according to various embodiments of the present application. In this regard, each block in a flowchart or block diagram may represent a module, segment, or portion of code containing one or more executable instructions for implementing a specified logical function. It should also be noted that in some alternative implementations, the functions indicated in the blocks may occur in a different order than those indicated in the drawings. For example, two consecutively indicated blocks may actually be executed substantially in parallel, and they may sometimes be executed in reverse order, depending on the functions involved. It should also be noted that each block in the block diagrams and/or flowcharts, and combinations of blocks in the block diagrams and/or flowcharts, can be implemented using a dedicated hardware-based system that performs the specified function or operation, or using a combination of dedicated hardware and computer instructions.

The modules described in the embodiments of the present application can be implemented in software or hardware. The names of the modules do not necessarily limit the functionality of the unit itself.

The readable storage medium provided in the present application is a computer-readable storage medium that stores computer-readable program instructions (i.e., a computer program) for executing the above-described sign language recognition method, and is capable of solving the technical problem of sign language recognition. Compared with the related art, the beneficial effects of the computer-readable storage medium provided in the present application are the same as the beneficial effects of the sign language recognition method provided in the above embodiments, and will not be repeated here.

Furthermore, the present application also proposes a computer program product, including a sign language recognition program. When the sign language recognition program is executed by a processor, the steps of the sign language recognition method described above are implemented.

The specific implementation of the computer program product in the present application is basically the same as the various embodiments of the sign language recognition method described above, and will not be repeated here.

It should be noted that, in this document, the terms “comprising”, “including” or any other variations thereof are intended to cover non-exclusive inclusion, such that a process, method, article, or system that includes a list of elements includes not only those elements but also other elements not expressly listed, or elements inherent to such a process, method, article, or system. Unless otherwise specified, an element defined by the phrase “comprising one . . . ” does not exclude the presence of other identical elements in the process, method, article, or system that includes that element.

The sequence numbers of the embodiments in the present application are for descriptive purposes only and do not represent the superiority or inferiority of the embodiments.

Through the above description of the embodiments, those skilled in the art can clearly understand that the methods of the above embodiments can be implemented by means of software plus necessary general-purpose hardware platforms. Of course, they can also be implemented by hardware, but in many cases the former is a better implementation method. Based on this understanding, the technical solution of the present application, in essence, or the part that contributes to the related art, can be embodied in the form of a software sensor. This computer software sensor is stored in a storage medium (such as ROM/RAM, magnetic disk, optical disk) as described above, and includes several instructions to cause a terminal device (which may be a mobile phone, computer, server, air conditioner, or network device, etc.) to execute the methods of the various embodiments of the present application.

The above descriptions are only some embodiments of the present application, and does not limit the patent scope of the present application. All equivalent structural transformations made by configuring the contents of the present application specification and drawings under the technical concept of the present application, or directly/indirectly applied in other related technical fields, are included in the patent protection scope of the present application.

What is claimed is:

1. A sign language recognition method, comprising:
obtaining video data to be applied to sign language recognition, wherein the video data comprises multiple frame images;
for each frame image, calculating a first similarity between the image and a preset reference image, and determining an image value corresponding to the image based on the first similarity; wherein the image value is positively correlated with the first similarity, and the preset reference image is an image containing valid sign language content; and
selecting keyframe images with image values greater than a preset threshold from each of the images, and inputting the keyframe images into a preset sign language recognition model to obtain sign language recognition results.

2. The sign language recognition method according to claim 1, wherein the determining the image value corresponding to the image based on the first similarity comprises:
obtaining adjacent frame images corresponding to the image, and calculating a second similarity between the image and the adjacent frame images, wherein the adjacent frame images are a previous frame image or a next frame image; and
calculating a weighted sum of the first similarity and the second similarity, and determining the weighted sum as the image value corresponding to the image.

3. The sign language recognition method according to claim 1, wherein the calculating the first similarity between the image and the preset reference image comprises:
calculating a Pearson correlation coefficient between the image and the preset reference image, and determining the Pearson correlation coefficient between the image and the preset reference image as the first similarity.

4. The sign language recognition method according to claim 1, wherein, after the obtaining video data to be applied to sign language recognition, the method further comprises:
obtaining an image sequence by arranging the images in chronological order, and determining a middle position of the image sequence; and
selecting the image corresponding to the middle position of the image sequence as a preset reference image.

5. The sign language recognition method according to claim 1, wherein the sign language recognition model comprises an input module, an encoding module, a decoding module, and a prediction head connected in sequence; the inputting the keyframe images into the preset sign language recognition model to obtain sign language recognition results comprises:
embedding and positionally encoding the keyframe image through the input module to obtain an input vector;
inputting the input vector into the encoding module to obtain an encoding matrix, wherein the encoding module is configured to encode the input vector;
inputting the encoding matrix into the decoding module to obtain a decoding matrix, wherein the decoding module is configured to decode the encoding matrix; and
inputting the decoding matrix into the prediction head to obtain the sign language recognition results.

6. The sign language recognition method according to claim 5, wherein the input module comprises an image embedding module, a key point embedding module, and a position encoding module; the embedding and positionally encoding the keyframe image through the input module to obtain the input vector comprises:
embedding the keyframe image through the image embedding module to obtain an image vector;
extracting key points from the keyframe image through the keypoint embedding module, and embedding the key points, to obtain a keypoint vector; and
performing position encoding on the image vector and the keypoint vector through the position encoding module to obtain an input vector, wherein the input vector comprises an image position encoding vector and a keypoint position encoding vector.

7. The sign language recognition method according to claim 6, wherein the encoding module comprises an image encoder stack, a keypoint encoder stack, and a fusion module; the inputting the input vector into the encoding module to obtain the encoding matrix comprises:
inputting the image position encoding vector from the input vector into the image encoder stack to obtain an image encoding matrix;
inputting the keypoint position encoding vector from the input vector into the keypoint encoder stack to obtain a keypoint encoding matrix; and
performing a weighted fusion of the image encoding matrix and the keypoint encoding matrix by the fusion module to obtain the encoding matrix.

8. The sign language recognition method according to claim 5, wherein the prediction head comprises a pooling layer, multiple regularization layers, and an output layer; the inputting the decoding matrix into the prediction head to obtain the sign language recognition results comprises:
inputting the decoding matrix into the pooling layer to obtain a fusion vector;
inputting the fusion vector into each of the regularization layers to obtain a regularization vector; and
inputting all the regularization vectors into the output layer to obtain the sign language recognition results.

9. A sign language recognition device, comprising: a memory, a processor, and a computer program stored in the memory and executable on the processor, wherein the computer program is configured to implement the steps of the sign language recognition method according to claim 1.

10. A readable storage medium, wherein the readable storage medium is a computer-readable storage medium, and a computer program is stored on the computer-readable storage medium, wherein when the computer program is executed by a processor, the steps of the sign language recognition method according to claim 1 are implemented.
